(19) United States
(12) Patent Application Publication
(10) Pub. No.: US 2022/0281141 A1
(43) Pub. Date: Sep. 8, 2022

(54) CRUSHED PIECES COLLECTOR

(71) Applicant: HONDA MOTOR CO., LTD., Tokyo (JP)

(72) Inventors: Syouji INOSE, Wako-shi (JP); Masaki NAMAIZAWA, Wako-shi (JP); Tadahiro SHIBA, Wako-shi (JP); Kazuhiro MIURA, Wako-shi (JP)

(21) Appl. No.: 17/680,634

(22) Filed: Feb. 25, 2022

(30) Foreign Application Priority Data
Mar. 2, 2021 (JP) 2021-032707

(51) Int. Cl. B29B 17/04; B02C 23/00; B23Q 11/00

(52) U.S. Cl. CPC B29B 17/04; B02C 23/00; B23Q 11/0067

(57) ABSTRACT

While a part of an article is crushed to be collected, a crushed pieces collector reduces the number of uncollected crushed pieces and the crushed pieces scattered over the floor to improve efficiency of collection and to prevent a foreign matter from being mixed into the collected crushed pieces. The crushed pieces collector is configured to collect the crushed pieces while a crush object is crushed to be removed from a fixed object to which the crush object is fixed. The crushed pieces collector includes: a receiving portion placed below the crush object to receive the crushed pieces; and a contact portion provided contiguously with the receiving portion and in contact with the fixed object. The contact portion includes an elastic body elastically deformable along an outer surface of the fixed object.

### CROSS-REFERENCE TO RELATED APPLICATIONS

The present application claims priority under 35 U.S.C. § 119 to Japanese Patent Application No. 2021-032707, filed Mar. 2, 2021, the contents of which are hereby incorporated by reference in their entirety.

### BACKGROUND OF THE INVENTION

### 1. Field of the Invention

The present invention relates to a container for collecting crushed pieces when crushing part of an article.

### 2. Description of the Related Art

Reuse of materials recovered from industrial products and the like has been a common practice. For example, JP2020-055257 describes a technique of breaking down carbon fiber reinforced plastic (CFRP) waste into fine particles while controlling the resin content. An apparatus according to JP2020-055257 is designed so that crushed pieces of CFRP, as raw material, are put into the apparatus. The apparatus is based on the recovered material which is beforehand separated from unwanted substances.

### SUMMARY OF THE INVENTION

In a case where a material intended to be recovered is fixed to part of an article, if only the material can be crushed, the material can be recovered by collecting of the crushed pieces. For example, in a case where a resin member of a light is intended to be recovered from a vehicle, the intention can be achieved by crushing only the resin member of the light fixed to the vehicle; and collecting the crushed pieces of the resin member. If, however, the crushed pieces scatter widely over the floor and the like due to the crush impact, the collecting of the crushed pieces requires much labor and time. Furthermore, if a foreign matter, such as dust and dirt on the floor and the like, is mixed with the crushed pieces, the foreign matter contaminates the collected crushed pieces, and degrades the quality of the crushed pieces as a recycled material.

The present invention has been made to solve the above problems and an object thereof is to enhance the collecting efficiency by reducing the amount of uncollected crushed pieces and the amount of crushed pieces scattered over the floor and the like, as well as to prevent the foreign matter from getting mixed into the collected crushed pieces when collecting crushed pieces obtained by crushing the part of the article.

A crushed pieces collector according to the present invention to solve the above problems is that which is configured to collect crushed pieces while a crush object is crushed to be removed from a fixed object to which the crush object is fixed. The crushed pieces collector includes: a receiving portion placed below the crush object and configured to receive the crushed pieces; and a contact portion provided contiguously with the receiving portion and in contact with the fixed object. Here, the contact portion includes an elastic body elastically deformable along an outer surface of the fixed object.

According to the present invention, while collecting crushed pieces obtained by crushing the part of the article, it is possible to enhance the collecting efficiency by reducing the amount of uncollected crushed pieces and the amount of crushed pieces scattered over the floor and the like, as well as to prevent a foreign matter from getting mixed into the collected crushed pieces.

### BRIEF DESCRIPTION OF THE DRAWINGS

FIG. 1 is a diagram showing, diagonally from above, the whole of a crushed pieces collector according to an embodiment.

FIG. 2 is a diagram showing, from above, an example of how the crushed pieces collector according to the embodiment is set up relative to a fixed object and a crush object.

FIG. 3A is a diagram showing, diagonally from above, the crushed pieces collector according to the embodiment with a receiving portion removed from the crushed pieces collector.

FIG. 3B is a diagram showing how arm portions look like after being moved from the state shown in FIG. 3A.

FIG. 3C is a diagram showing how the arm portions look like after being moved further from the state shown in FIG. 3A.

### DETAILED DESCRIPTION OF THE EMBODIMENTS

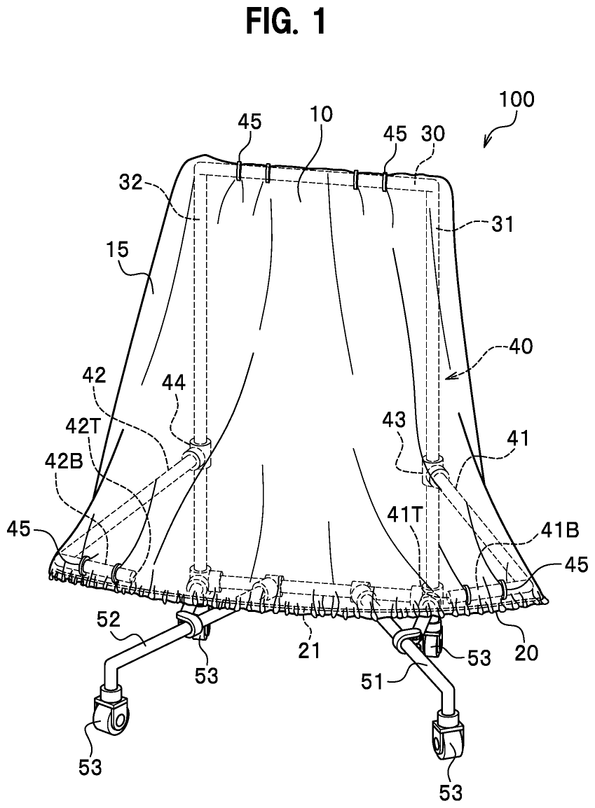

An embodiment of the present invention will be hereinafter described in detail with reference to the drawings. As shown in FIG. 1, a crushed pieces collector 100 according to the embodiment of the present invention includes a receiving portion 10, a contact portion 20, a main frame 40, arm portions 41, 42, and leg portions 51, 52.

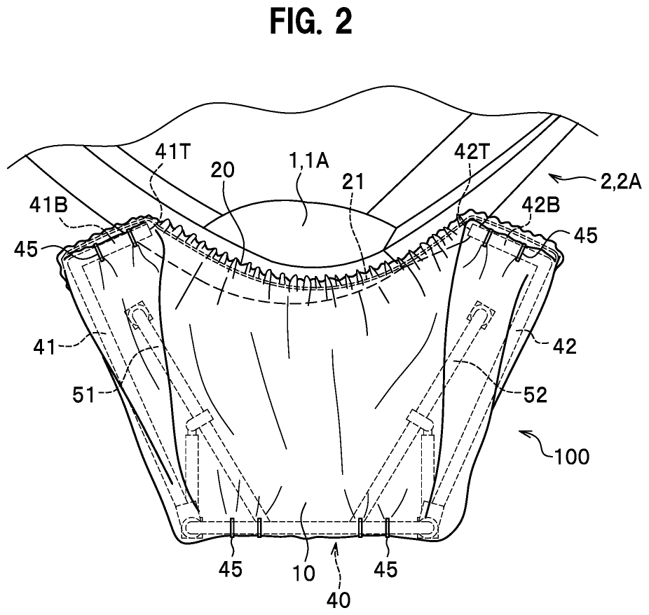

FIG. 2 shows an example where: a crush object 1 intended to be crushed is a resin member 1A of a light body; and a fixed object 2 to which the crush object 1 is fixed is a vehicle 2A. The crushed pieces collector 100 is used to collect crushed pieces of the resin member 1A when the resin member 1A is crushed to be removed from the vehicle 2A to which the resin member 1A is fixed.

### (Receiving Portion)

The receiving portion 10 is a member serving as a container for receiving the crushed pieces. As shown in FIG. 2, the receiving portion 10 is placed lower than the resin member 1A of the light body which is the crush object 1.

A flexible sheet-shaped or bag-shaped member, for example, may be used as the receiving portion 10. In a case where the receiving portion 10 is bag-shaped, the receiving portion 10 is easily set up relative to the main frame or the like, which will be described later.

It is desirable that a material of the receiving portion 10 be soft and have a smooth surface. In a case where the receiving portion 10 is made of the soft material having the smooth surface, the crushed pieces slide over the receiving portion 10 and are thus easily collected into a single place. This makes it possible to enhance the collecting efficiency.

Furthermore, it is desirable that the surface of the receiving portion 10 be in white tone. The white tone makes it easy to distinguish the crushed pieces from, for example, other black members and the like when the black members or the like are removed by hands from mixture of the crushed pieces, the black members and the like.

A material of type similar to the material of a cover for the vehicle may be used as the material of the receiving portion 10. Otherwise, for example, the cover for the hood of the vehicle, or the like thing, may be used as the material of the receiving portion 10.

### (Contact Portion)

The contact portion 20 is a member put into contact with the fixed object 2 contiguously with the receiving portion 10. As shown in FIG. 2, the contact portion 20 is placed lower than the resin member 1A of the light body which is the crush object 1, and along an outer surface of the vehicle 2A which is the fixed object 2.

The contact portion 20 includes an elastic body 21 which is able to elastically change its shape along the outer surface of the vehicle 2A which is the fixed object 2. The position at which the resin member 1A is fixed is a corner portion of the vehicle 2A. The elastic body 21 elastically changes its shape along the outer surface of the vehicle 2A which includes a corner portion of the vehicle 2A, and thus allows the contact portion 20 to get into contact with the vehicle 2A along the outer surface of the vehicle 2A. The contact portion 20 is made, for example, from: a tube formed from part of the peripheral edge of the sheet-shaped receiving portion 10; and a string-shaped rubber member which is inserted through the tube.

### (Main Frame)

The main frame 40 is a member for supporting the receiving portion 10 in corporation with the arm portions 41, 42, which will be described later. The main frame 40 includes a holder receiving portion 30 to which the receiving portion 10 is fixed, and supporting portions 31, 32 for supporting the holder receiving portion 30. As a whole, the main frame 40 is shaped like a square frame. The receiving portion 10 is fixed to the holder receiving portion 30 using holders 45.

In this case, the holder receiving portion 30 is a beam-shaped member, and is placed in the lateral direction. For the purpose of preventing the crushed pieces from scattering toward the outside of the receiving portion 10, it is desirable that: the length of the holder receiving portion 30 be longer than the width of the crush object 1 which faces the holder receiving portion 30; and the position of the holder receiving portion 30 in the height direction be higher than that at which the crush object 1 is fixed.

At its two ends, the holder receiving portion 30 is supported by the supporting portions 31, 32. In this case, the supporting portions 31, 32 are columnar members, respectively, and at the upper end sides of the supporting portions 31, 32 are located respectively at the two ends of the holder receiving portion 30. A beam-shaped member is horizontally stretched between the lower end sides of the respective supporting portions 31, 32.

### (Arm Portions)

The arm portions 41, 42 are each a member for supporting the receiving portion 10 in cooperation with the main frame 40. Ends of the arm portions 41, 42 are respectively fixed to attachment portions 43, 44 provided to the supporting portions 31, 32 of the main frame 40, and extend from the main frame 40 toward the fixed object 2.

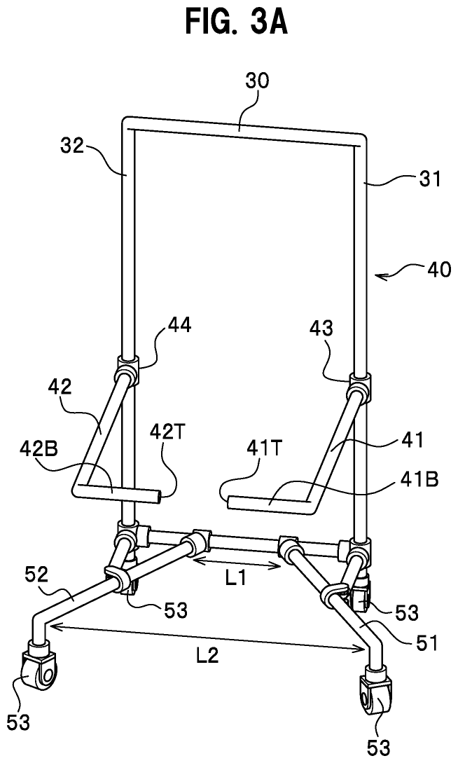

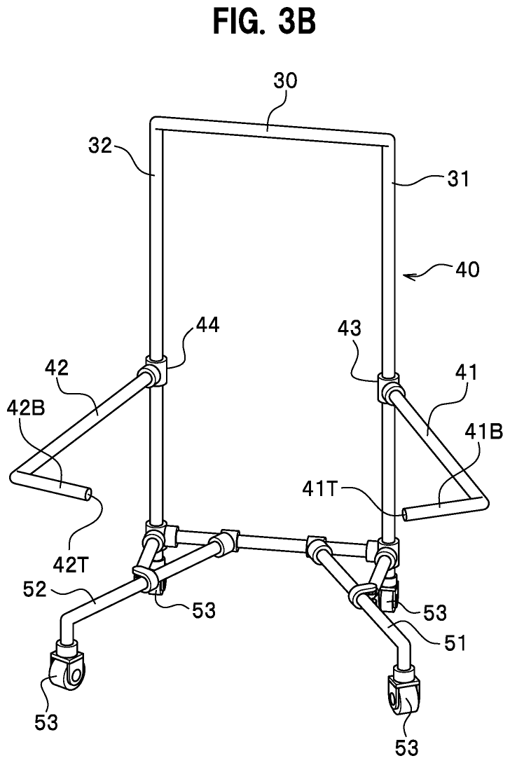

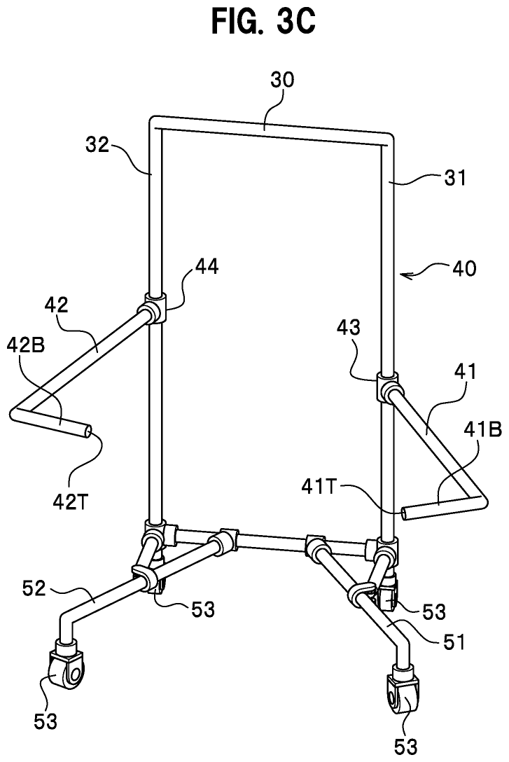

The attachment portions 43, 44 respectively support the arm portions 41, 42 rotatably in the lateral direction. Thereby, distal end portions 41T, 42T of the arm portions 41, 42 are movable such that the receiving portion 10 is enlarged or reduced, as shown in FIGS. 3A and 3B. Furthermore, height-direction positions of the respective attachment portions 43, 44 are adjustable, as shown in FIG. 3C where the height of the attachment portion 44 is adjusted. By this, the arm portions 41, 42 are movable in the height direction. Furthermore, the arm portions 41, 42 may be configured to be fixed at their respective rotated positions.

At their distal ends, the arm portions 41, 42 include bent portions 41A, 42B which bend toward the fixed object 2, respectively. The receiving portion 10 is fixed to the bent portions 41A, 42B using holders 45. The length of the receiving portion 10 and the length of the contact portion 20 between the distal end portions 41T, 42T can be adjusted, for example, by moving the bent portions 41A, 42B relative to the receiving portion 10 before the receiving portion 10 gets fixed to the bent portions 41A, 42B.

As shown in FIG. 2, the distal end portions 41T, 42T of the respective arm portions 41, 42 push the contact portion 20 in contact with the vehicle 2A. Thereby, the elastic body 21 of the contact portion 20 is in the state of being provided stretching between the distal end portions 41T, 42T along the outer surface of the vehicle 2A.

Incidentally, as shown in FIG. 1, a side wall portion 15 for catching crushed pieces scattering in the lateral direction can be provided by adjusting the shape of the receiving portion 10 between the main frame 40 and each of the bent portions 41A, 42B.

### (Leg Portions)

The leg portions 51, 52 are each a member for supporting the main frame 40. As shown in FIG. 3A, the two leg portions 51, 52 extend from the lower end side of the main frame 40. The leg portions 51, 52 are placed in a side of the main frame 40 which is the same as the receiving portion 10 is provided.

Ends of the respective leg portions 51, 52 are fixed to the main frame 40. Furthermore, the leg portions 51, 52 are placed in parallel to the floor or the like such that the distance between the leg portions 51, 52 become gradually wider, for example from a distance L1 to a distance L2, as the leg portions 51, 52 become farther from the main frame 40. The crushed pieces collector 100 is used with the extending side of the leg portions 51, 52 directed toward the fixed object 2. The distance between the leg portions 51, 52 becomes gradually wider toward the fixed object 2.

Each of the leg portions 51, 52 includes at least one wheel 53. The crushed pieces collector 100 includes four wheels 53. Each wheel 53 includes a brake. The brake may be configured, for example, to stop the rotation of the corresponding wheel 53, or to generate a friction force between the wheel 53 and the floor or the like.

The crushed pieces collector 100 according to the present invention is that which is used to collect the crushed pieces when the crush object 1 is crushed to be removed from the fixed object 2 to which the crush object 1 is fixed. The crushed pieces collector 100 includes: the receiving portion 10, placed lower than the crush object 1, for receiving the crushed pieces; and the contact portion 20 provided contiguously with the receiving portion 10, and put into contact with the fixed object 2. The contact portion 20 includes the elastic body 21 able to elastically change its shape along the outer surface of the fixed object 2.

This configuration enables the crushed pieces collector 100 to collect the crushed pieces, using the receiving portion 10 placed lower than the crush object 1 before the crushed pieces fall onto the floor and the like, and thus to prevent the mixture of a foreign matter from the floor and the like from entering the crushed pieces. Furthermore, since the contact portion 20 provided contiguously with the receiving portion 10, and put into contact with the fixed object 2, is placed between the receiving portion 10 and the fixed object 2, the contact portion 20 can prevent the crushed pieces from falling onto the floor or the like. Moreover, since the contact portion 20 includes the elastic body 21 able to elastically change its shape along the outer surface of the fixed object 2, the contact portion 20 reduces the gap between the contact portion 20 and the outer surface of the fixed object 2. Accordingly, the crushed pieces collector 100 can collect the crushed pieces efficiently.

It is desirable that the crushed pieces collector 100 according to the present invention further includes: the main frame 40 for supporting the receiving portion 10; and one or plural arm portions, extending from the main frame 40 toward the fixed object 2, for supporting the receiving portion 10. It is also desirable that at least one arm portion of the one or plural arm portions be movable such that the receiving portion 10 is enlarged or reduced.

Because of this configuration, the receiving portion 10 can be stably set up using the main frame 40 and the arm portion extending from the main frame 40 toward the fixed object 2. In addition, since the size of the receiving portion 10 and the range where the receiving portion 10 is positioned relative to the crush object 1 are adjusted using the main frame 40 and the arm portion movable such that the receiving portion 10 is enlarged or reduced, the crushed pieces collector 100 can collect the crushed pieces more efficiently.

In addition, the tension of the elastic body 21 of the contact portion 20 put in contact with the fixed object 2 can be adjusted using the arm portions movable such that the receiving portion 10 is enlarged or reduced. For example, when the crushed pieces collector 100 is put closer to the corner portion of the vehicle 2A, the arm portions move such that the receiving portion 10 is enlarged, and the elastic body 21 of the contact portion 20 is stretched along the outer surface of the vehicle 2A so that the tension of the elastic body 21 increases. Since the tension of the elastic body 21 reduces the gap between the contact portion 20 and the outer surface of the fixed object 2, the crushed pieces collector 100 can further prevent the crushed pieces from falling onto the floor or the like.

Furthermore, the tension of the elastic body 21 works on the arm portions such that the receiving portion 10 is reduced. When the crushed pieces collector 100 is put farther from the vehicle 2A, the tension of the elastic body 21 makes the arm portions move such that the receiving portion 10 is reduced. For this reason, the arm portions can be moved by changing the distance between the crushed pieces collector 100 and the vehicle 2A. Accordingly, the crushed pieces collector 100 can enhance the collecting efficiency.

Incidentally, in the case where the crushed pieces collector includes, for example, the single arm portion 41, the arm portion 41 moves relative to the main frame 40 such that the receiving portion 10 is enlarged or reduced. Otherwise, in the case where the crushed pieces collector includes, for example, the two arm portions 41, 42, the arm portion 41, 42 changes the distance therebetween by moving relative to the main frame 40 such that the receiving portion 10 is enlarged or reduced.

It is desirable that in the crushed pieces collector 100 according to the present invention, at least the distal end portions 41T, 42T of the respective arm portions 41, 42 be movable in the height direction.

When the distal end portions 41T, 42T of the respective arm portions 41, 42 are moved in the height direction, this configuration makes it possible to adjust the position and direction of the contact portion 20 put into contact with the fixed object 2, in accordance with the height and direction in which the crush object 1 is fixed, as well as the outer shape of the crush object 1. Accordingly, the crushed pieces collector 100 can further prevent the crushed pieces from falling onto the floor or the like.

It is desirable that in the crushed pieces collector 100 according to the present invention, at their distal ends, the arm portions 41, 42 respectively include the bent portions 41B, 42B bent toward the fixed object 2.

This configuration enables the crushed pieces collector 100 to catch the crushed pieces in a wider range by increasing the area of the receiving portion 10 using the bent portions 41B, 42B.

It is desirable that: the crushed pieces collector 100 according to the present invention further include the two leg portions 51, 52 extending from the lower end side of the main frame 40 toward the fixed object 2; and the distance between the leg portions 51, 52 becomes gradually wider toward the fixed object 2.

This configuration makes the fixed object 2 located between the leg portions 51, 52, even in the case where the crush object 1 is fixed to the corner portion of the fixed object 2. Accordingly, the crushed pieces collector 100 can be put closer to the fixed object 2 with the leg portions 51, 52 prevented from interfering in the fixed object 2.

It is desirable that in the crushed pieces collector 100 according to the present invention, the leg portions 51, 52 each include the wheel 53 equipped with the brake.

This configuration enables the crushed pieces collector 100 to easily move using the wheels 53, and makes it easy to adjust the position and direction of the crushed pieces collector 100 relative to the crush object 1 and the fixed object 2. Furthermore, for example, when the crushed pieces collector is put closer to the corner portion of the vehicle 2A, the arm portions move such that the receiving portion 10 is enlarged, and the elastic body 21 of the contact portion 20 is stretched along the outer surface of the vehicle 2A. Accordingly, the crushed pieces collector 100 receives a force which pushes back the crushed pieces collector 100 in a direction farther from the vehicle 2A. Since each wheel 53 includes the brake, the movement of the crushed pieces collector 100 can be stopped in the adjusted position and direction.

It is desirable that the crushed pieces collector 100 according to the present invention be used to crush and collect the resin member 1A of the light body as the crush object 1 from the vehicle 2A as the fixed object 2.

This configuration makes it possible to prevent a foreign matter adhering to the underbody of the vehicle 2A and a foreign matter existing on the floor or the like from getting mixed into the crushed pieces, when the resin member 1A of the light body fixed to the vehicle 2A is crushed to be removed. Accordingly, the quality of the collected crushed pieces as the recycled material can be enhanced.

Another crushed pieces collector according to the present invention is that which is used to collect the crushed pieces when the crush object 1 is crushed to be removed from the fixed object 2 to which the crush object 1 is fixed. The crushed pieces collector includes: the receiving portion 10, placed lower than the crush object 1, for receiving the crushed pieces; the contact portion 20 provided contiguously with the receiving portion 10, and put into contact with the fixed object 2; the main frame 40 for supporting the receiving portion 10; and the one or plural arm portions, extending from the main frame 40 toward the fixed object 2, for supporting the receiving portion 10. The receiving portion 10 is flexible. At least one arm portion of the one or plural arm portions is movable relative to the main frame 40 such that the receiving portion 10 is enlarged or reduced.

This configuration enables the other crushed pieces collector to collect the crushed pieces using the receiving portion 10 placed lower than the crush object 1, before the crushed pieces fall onto the floor or the like, and thus prevents the mixture of the foreign matter from the floor or the like from entering the crushed pieces. Moreover, since the contact portion 20 provided contiguously with the receiving portion 10, and put into contact with the fixed object 2, is located between the receiving portion 10 and the fixed object 2, the crushed pieces collector can prevent the crushed pieces from falling onto the floor or the like.

In addition, the receiving portion 10 can be stably set up using the main frame 40 and the arm portion extending from the main frame 40 toward the fixed object 2. Since the size of the receiving portion 10 and the range where the receiving portion 10 is positioned relative to the crush object 1 are adjusted using the main frame 40 and the arm portion movable such that the receiving portion 10 is enlarged or reduced, the crushed pieces collector can collect the crushed pieces efficiently.

Furthermore, the contact portion 20 contiguously with the flexible receiving portion 10 can be provided with stretch along the outer surface of the fixed object 2, using the arm portion movable such that the receiving portion 10 is enlarged or reduced. Accordingly, the crushed pieces collector can collect the crushed pieces more efficiently by reducing the gap between the contact portion 20 and the outer surface of the fixed object 2.

### First Modification

Descriptions will be provided for a first modification in which the contact portion includes no elastic body 21.

A crushed pieces collector according to the first modification is different from the crushed pieces collector 100 in terms of the contact portion without elastic body 21.

The contact portion according to the first modification does not have the elastic body 21 but has a flexibility. Using the distal end portions 41T, 42T, the contact portion according to the first modification is pushed into contact with the fixed object 2, like the crushed pieces collector 100. In this case, the contact portion can be put into contact with and along the outer surface of the fixed object 2, by adjusting the distance between the distal end portions 41T, 42T such that the contact portion is provided with stretch between the distal end portions 41T, 42T. The length of the contact portion may be adjusted between the distal end portions 41T, 42T.

### Second Modification

Next, descriptions will be provided for a second modification which includes a single arm portion.

A crushed pieces collector according to the second modification is different from the crushed pieces collector 100 in terms of the crushed pieces collector including the single arm portion. In this case, descriptions will be provided for the second embodiment which includes the single arm portion 41.

Using the holders 45, the receiving portion 10 is fixed to the holder receiving portion 30 of the main frame 40, the supporting portion 31 of the main frame 40, and the bent portion 41B of the arm portion 41. The arm portion 41 is rotatable relative to the supporting portion 31, and is movable relative to the main frame 40 (more specifically, the other supporting portion 32) such that the receiving portion 10 is enlarged or reduced. Thus, the distal end portion 41T of the arm portion 41 and the supporting portion 31 of the main frame 40 are put into contact with the outer surface of the fixed object 2. In other words, the contact portion 20 is pushed into contact with the vehicle 2A using the distal end portion 41T and part of the supporting portion 31 which gets into contact with the fixed object 2. The elastic body 21 of the contact portion 20 gets into the state of being provided with stretch between the distal end portion 41T and the supporting portion 31 along the outer surface of the vehicle 2A.

Moreover, the first and second modifications may be combined together.

Incidentally, the holder receiving portion 30 of the main frame 40 has the straight shape in the drawings. However, the holder receiving portion 30 of the main frame 40 may have a curving shape, for example an arc shape. The shape of the holder receiving portion 30 enables the shape of the receiving portion 10 to be adjusted in accordance with a direction in which the crushed pieces scatter.

The supporting portions 31, 32 of the main frame 40 are provided in the two respective positions which are away from each other. However, the supporting portions 31, 32 of the main frame 40 may be integrated into a single supporting portion. The integration makes it easy to adjust the shape of the main frame. In this case, the arm portions 41, 42 may be extended, for example, from a supporting portion which is the single columnar member. Furthermore, the main frame 40 may be the single columnar member.

The arm portions 41, 42 may be configured to rotate in the vertical direction using the attachment portions 43, 44. The rotation of the arm portions 41, 42 in the vertical direction enables the distal end portion 41T, 42T to move in the height direction.

The arm portions 41, 42 may be configured to be able to adjust their lengths. The adjustment of the lengths makes it possible to reduce the gap between the contact portion 20 and the fixed object 2, and thus finely adjusts the positions of the distal end portions 41T, 42T such that the receiving portion 10 locates in directions in which crushed pieces fall or scatter. Moreover, the arm portions 41, 42 may have a curved shaped, for example, an arc shape.

What is claimed is:

1. A crushed pieces collector configured to collect crushed pieces while a crush object is crushed to be removed from a fixed object to which the crush object is fixed,
the crushed pieces collector comprising:
a receiving portion placed below the crush object and configured to receive the crushed pieces; and
a contact portion provided contiguously with the receiving portion and in contact with the fixed object, wherein
the contact portion includes an elastic body elastically deformable along an outer surface of the fixed object.

2. The crushed pieces collector according to claim 1, further comprising:
a main frame supporting the receiving portion; and
one or plural arm portions extending from the main frame toward the fixed object and supporting the receiving portion, wherein
at least one arm portion of the one or plural arm portions is movable such that the receiving portion is enlarged or reduced.

3. The crushed pieces collector according to claim 2, wherein at least a distal end portion of the arm portion is movable in a height direction.

4. The crushed pieces collector according to claim 2, wherein the arm portion includes a distal end and a bent portion bent toward the fixed object at the distal end.

5. The crushed pieces collector according to claim 2, further comprising
two leg portions extending from a lower side of the main frame toward the fixed object, wherein
a distance between the two leg portions becomes gradually wider toward the fixed object.

6. The crushed pieces collector according to claim 5, wherein each of the leg portions includes a wheel equipped with a brake.

7. The crushed pieces collector according to claim 1, wherein the crushed pieces collector is configured to crush and remove a resin member of a light body of the crush object from a vehicle as the fixed object.

8. A crushed pieces collector used to collect crushed pieces while a crush object is crushed to be removed from a fixed object to which the crush object is fixed, comprising:
a receiving portion placed below the crush object and configured to receive the crushed pieces;
a contact portion provided contiguously with the receiving portion and in contact with the fixed object;
a main frame supporting the receiving portion; and
one or plural arm portions extending from the main frame toward the fixed object and supporting the receiving portion, wherein
the receiving portion has a flexibility, and
at least one arm portion of the one or plural arm portions is movable relative to the main frame such that the receiving portion is enlarged or reduced.
